(19) United States
(12) Patent Application Publication
(10) Pub. No.: US 2024/0217581 A1
(43) Pub. Date: Jul. 4, 2024

(54) Vehicle Lane Control System

(71) Applicant: Karma Automotive LLC, Irvine, CA (US)

(72) Inventor: Khushwant Peswani, Irvine, CA (US)

(73) Assignee: Karma Automotive LLC, Irvine, CA (US)

(21) Appl. No.: 18/148,623

(22) Filed: Dec. 30, 2022

(51) Int. Cl. B62D 15/02; B62D 6/00

(52) U.S. Cl. CPC B62D 15/0255; B62D 6/00

(57) ABSTRACT

A method includes determining that a driver of a vehicle activated a turn signal of the vehicle, the turn signal indicating a driver intention to change lanes from a first lane of a road into a second lane of the road; and, in response to determining that the turn signal is activated, defining a virtual soft barrier between the first lane and a third lane of the road, the third lane on an opposite side of the first lane from the second lane. The method also includes determining that a position of the vehicle relative to the virtual soft barrier satisfies a criteria; and, in response to determining that the position of the vehicle relative to the virtual soft barrier satisfies the criteria, directing an electronic steering system of the vehicle to provide a counter-steering nudge that prevents the vehicle from entering the third lane.

### TECHNICAL FIELD

The present disclosure relates to driver assistance systems and, more particularly, to vehicle lane control systems.

### BACKGROUND

A vehicle typically includes multiple driver assistance systems, such as a lane departure warning system and a lane keeping support system. In conventional vehicles, lane departure warnings are suppressed and lane keep support features are disabled when a driver activates a turn signal to indicate their intention to change lanes from a first lane of a road into an adjacent second lane of the road.

### SUMMARY

One aspect of the disclosure provides a computer-implemented method executed on data processing hardware that causes the data processing hardware to perform operations. The operations including determining that a driver of a vehicle activated a turn signal of the vehicle, the turn signal indicating a driver intention to change lanes from a first lane of a road into a second lane of the road; and, in response to determining that the turn signal is activated, defining a virtual soft barrier between the first lane and a third lane of the road, the third lane on an opposite side of the first lane from the second lane. The operations also include determining that a position of the vehicle relative to the virtual soft barrier satisfies a criteria; and, in response to determining that the position of the vehicle relative to the virtual soft barrier satisfies the criteria, directing an electronic steering system of the vehicle to provide a counter-steering nudge that prevents the vehicle from entering the third lane.

Implementations of the disclosure may include one or more of the following optional features. In some implementations, determining that the position of the vehicle relative to the virtual soft barrier satisfies the criteria includes determining that a distance between the vehicle and the virtual soft barrier satisfies a threshold distance. In some examples, the operations include receiving a user input, and setting the threshold distance based on the user input. In some implementations, the operations include receiving an output of a sensor, determining the distance based on the output of the sensor. The sensor may include an optical sensor. The optical sensor may include at least one of a camera, a radio detection and ranging (RADAR) system, or a light detection and ranging (LIDAR) system.

In some examples, the operations include determining that the turn signal is deactivated and, in response to determining that the turn signal is deactivated, deactivating the virtual soft barrier. The virtual soft barrier may be a lane marking between the first lane and the third lane. The third lane may be a shoulder lane. The second lane may be a lane for traffic in an opposite direction.

In some implementations, the operations include receiving a driver steering input, and discontinuing the counter-steering nudge in response to the driver steering input. In some examples, the operations adapting a strength of the counter-steering nudge based on a sensed condition. The sensed condition may be at least one of a lateral speed, a presence of an object in the third lane, or an avoidance criticality.

Another aspect of the disclosure provides a system including data processing hardware and memory hardware in communication with the data processing hardware. The memory hardware storing instructions that, when executed on the data processing hardware, cause the data processing hardware to perform operations. The operations including determining that a driver of a vehicle activated a turn signal of the vehicle, the turn signal indicating a driver intention to change lanes from a first lane of a road into a second lane of the road; and, in response to determining that the turn signal is activated, defining a virtual soft barrier between the first lane and a third lane of the road, the third lane on an opposite side of the first lane from the second lane. The operations also include determining that a position of the vehicle relative to the virtual soft barrier satisfies a criteria; and, in response to determining that the position of the vehicle relative to the virtual soft barrier satisfies the criteria, directing an electronic steering system of the vehicle to provide a counter-steering nudge that prevents the vehicle from entering the third lane.

Implementations of the disclosure may include one or more of the following optional features. In some implementations, determining that the position of the vehicle relative to the virtual soft barrier satisfies the criteria includes determining that a distance between the vehicle and the virtual soft barrier satisfies a threshold distance. In some examples, the operations include receiving a user input, and setting the threshold distance based on the user input. In some implementations, the operations include receiving an output of a sensor, determining the distance based on the output of the sensor. The sensor may include an optical sensor. The optical sensor may include at least one of a camera, a radio detection and ranging (RADAR) system, or a light detection and ranging (LIDAR) system.

In some examples, the operations include determining that the turn signal is deactivated and, in response to determining that the turn signal is deactivated, deactivating the virtual soft barrier. The virtual soft barrier may be a lane marking between the first lane and the third lane. The third lane may be a shoulder lane. The second lane may be a lane for traffic in an opposite direction.

In some implementations, the operations include receiving a driver steering input, and discontinuing the counter-steering nudge in response to the driver steering input. In some examples, the operations adapting a strength of the counter-steering nudge based on a sensed condition. The sensed condition may be at least one of a lateral speed, a presence of an object in the third lane, or an avoidance criticality.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a perspective view of an example vehicle having a vehicle lane control system.

FIGS. 2A and 2B depict a vehicle operating scenario showing an example operation of the vehicle lane control system of FIG. 1.

FIG. 3 is a flowchart of an exemplary arrangement of operations for a computer-implemented method of controlling a vehicle lane change.

FIG. 4 is a schematic view of an example computing device that may be used to implement the systems and methods described herein.

Like reference symbols in the various drawings indicate like elements.

### DETAILED DESCRIPTION

A vehicle typically includes multiple driver assistance systems, such as a lane departure warning system and a lane keeping support system. In conventional vehicles, lane departure warnings are suppressed and lane keep support features are disabled when a driver activates a turn signal to indicate their intention to change lanes from a current first lane of a road into an adjacent target second lane of the road. It has been found that drivers are often distracted while they are changing lanes. For example, a driver often loses focus on the road or their surroundings while looking at side mirrors and/or monitoring for traffic in a blind zone of the vehicle. This may result in the vehicle unintentionally drifting into a wrong third lane of the road that is on an opposite side of the first lane from the second lane. Such an unintentional lane departure may create a hazardous driving situation, especially when there is another vehicle or object in the third lane. Accordingly, implementations herein include a vehicle lane control system that can help prevent such unintentional, opposite-direction lane departures during lane changes. In particular, disclosed vehicle lane control systems continuously monitor a position of the vehicle relative a virtual soft barrier defined between the first lane and the third lane (e.g., corresponding to lane markings between the first lane and the third lane) and, when the relative position satisfies a criteria (e.g., the distance is less than the threshold distance), helps prevents an unintended lane departure into the third lane by, for example, providing a warning to the driver or directing an electronic steering system of the vehicle to provide a counter-steering nudge that helps prevent the vehicle from entering the third lane. The virtual soft barrier can be overridden by the driver at any time. While implementations are described with reference to lane changes, disclosed implementations may also be used to help prevent unintentional lane departures when making turns.

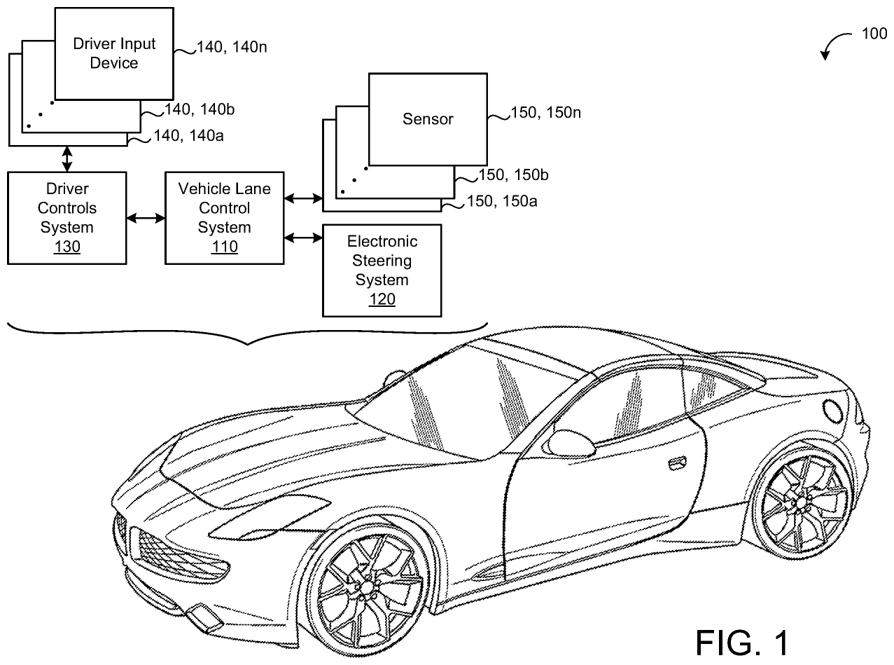

FIG. 1 is a perspective view of an example vehicle 100 equipped with a vehicle lane control system 110 for helping to prevent an unintended lane departure into a wrong lane during a lane change. Although the example shown depicts the vehicle 100 as a passenger car, the vehicle lane control system 110 may be installed on any suitable vehicle 100, such as, but not limited to, a truck, a sport utility vehicle (SUV), a motor cycle, a mass transit vehicle such as a bus, or an off-road or all-terrain vehicle.

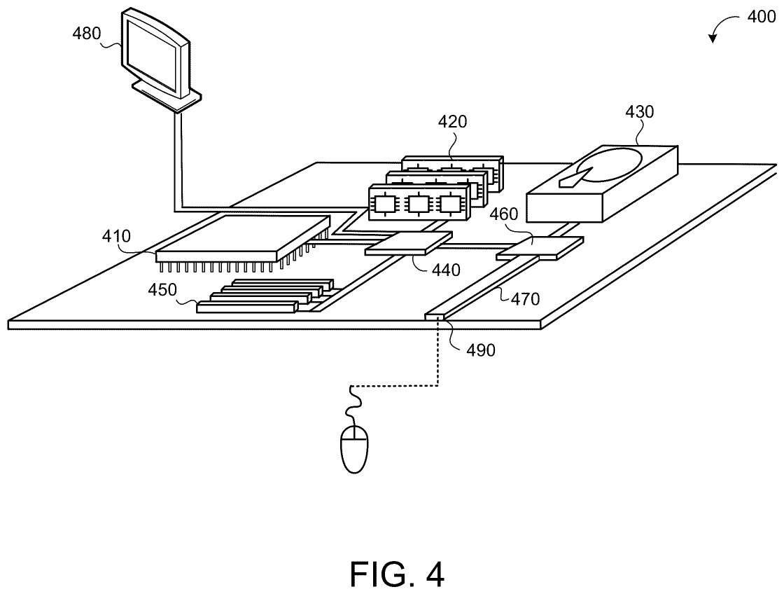

The vehicle 100 includes data processing hardware 410 (FIG. 4) and memory hardware 420 (FIG. 4) in communication with the data processing hardware 410. The memory hardware 420 stores instructions that, when executed on the data processing hardware 410, cause the data processing hardware 410 to perform operations. For example, the memory hardware 420 stores instructions for performing operations for implementing the vehicle lane control system 110. In some examples, the data processing hardware 410 also executes instructions for implementing one or more other systems of the vehicle 100 (e.g., an electronic steering system 120, a driver controls system 130, a braking system, or an environmental controls system). However, the vehicle 100 may include multiple instances of the data processing hardware 410 and memory hardware 420 as separate electronic control units (ECUs) or embedded controllers for executing various combinations of the systems of the vehicle 100. For example, first data processing hardware 410 may implement the vehicle lane control system 110 while second data processing hardware 410 implements the electronic steering system 120, third data processing hardware 410 implements the driver controls system 130, and fourth data processing hardware 410 performs overall control for the vehicle 100.

The electronic steering system 120 includes any known steering system(s) that are capable of being controlled via electrical signals from a vehicle control system, such as the vehicle lane control system 110. The driver controls system 130 includes any system(s) capable of capturing driver inputs via one or more driver input devices 140, 140a-n. An example driver input device 140a include a turn signal indicator (e.g., a turn signal lever or button) that a driver may activate to indicate their intention to change lanes from a first lane of a road into a second lane of the road. The driver input device 140a for the turn signal indicator could also include an optical sensor that detects gestures, eye gaze, or eye blinks indicating an intention to change lanes. The driver input device 140a could similarly include a microphone that accepts voice commands spoken by the driver indicating the driver's intention to change lanes.

The vehicle 100 includes one or more sensors 150, 150a-n for providing outputs that can be processed for detecting objects (e.g., lanes, lane markings, obstacles, other vehicles, etc.) or determining positions of the vehicle 100 relative to detected objects (e.g., a distance between the vehicle 100 and an object). Example sensors 150 include optical sensors, such as a camera (e.g., a front windshield camera), radio detection and ranging (RADAR) system, or a light detection and ranging (LIDAR) system (which may also be referred to as a laser imaging, detection, and ranging system). Other example systems could include any accelerometers and/or geographical positioning system (GPS) sensors. In some examples, the vehicle lane control system 110 processes outputs of one or more of the sensors 150 for detecting objects and positions of the vehicle 100 relative to detected objects. Alternatively, another system (not shown for clarity of illustration) processes outputs of one or more of the sensors 150 for detecting objects and positions of the vehicle 100 relative to detected objects, and provides information related to detected objects and relative positions to the vehicle lane control system 110.

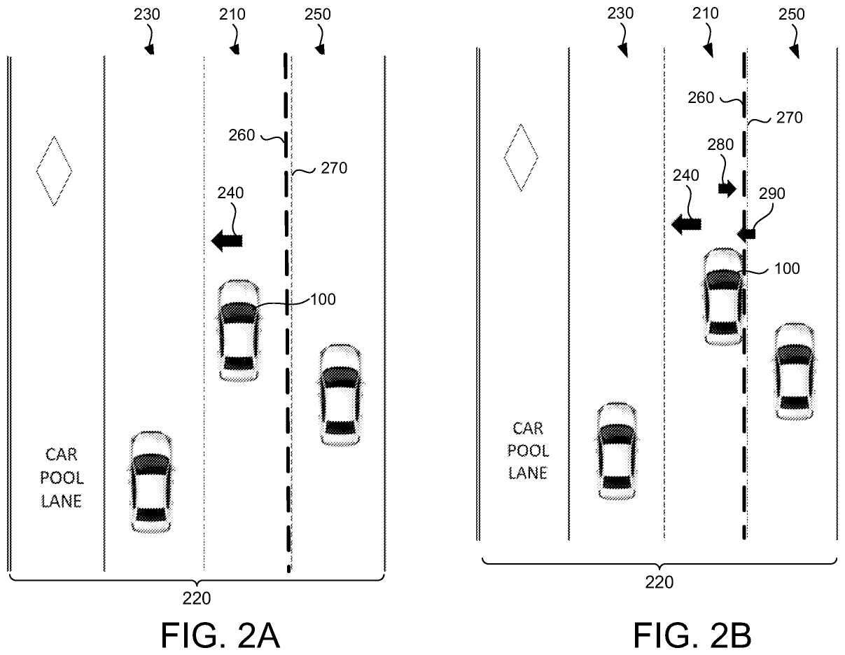

FIGS. 2A and 2B depict a vehicle operating scenario showing an example operation of the vehicle lane control system 110. In the example scenario of FIGS. 2A and 2B, a driver who is currently operating the vehicle 100 in a current first lane 210 of a road 220 intends to change lanes from the first lane 210 into an adjacent target second lane 230 that is adjacent to the first lane 210 (as depicted by arrow 240). In the example shown, the second lane 230 is to the left of the first lane 210. The second lane 230 may be for other vehicles traveling in the same direction as, or in the opposite direction of the vehicle 100.

When the vehicle lane control system 110 detects the intended lane change (e.g., by receiving an input from the driver control system 130 that indicates that the driver activated the turn signal indicator 140a to indicate a left lane change), the vehicle lane control system 110 defines a virtual soft barrier 260 between the first lane 210 and a wrong third lane 250 of the road 220 that is adjacent to, and on an opposite side of the first lane 210 from the second lane 230. The virtual soft barrier 260 can be overridden by the driver at any time. In the example shown, the third lane 250 is to the right of the first lane 210. The third lane 250 may be, for example, another traffic lane, a median, or a shoulder. Notably, because lane markings 270 on the road 220 that are between, separate, distinguish or otherwise delineate the first lane 210 from the third lane 250 can be tracked using outputs of one or more of the sensors 150, in some examples, the vehicle lane control system 110 defines the virtual soft barrier 260 to correspond to the lane markings 270. However, other virtual soft barriers may be defined including those that may not be visible to the naked eye.

The vehicle lane control system 110 monitors the distance between the vehicle 100 and the virtual soft barrier 260 (e.g., the lane markings 270). That is, the vehicle lane control system 110 determines and tracks amounts of unintentional drift. In some examples, the vehicle lane control system 110 processes outputs of one or more of the sensors 150 for determining distances from the vehicle 100 to the lane markings 270. Alternatively, another system of the vehicle 100 determines and provides distances between the vehicle 100 and the lane markings 270 to the vehicle lane control system 110. When, as shown in FIG. 2B by direction of arrow 280, the vehicle 100 drifts toward the virtual soft barrier 260 (e.g., the lane markings 270) and the position of the vehicle 100 satisfies a criteria relative to the virtual soft barrier 260, the vehicle lane control system 110 at least one of provides a warning to the driver or directs the electronic steering system 120 of the vehicle to provide a counter-steering nudge (as designated with arrow 290) to help prevent the vehicle 100 from entering the third lane 250. Example criteria include a distance from the vehicle 100 to the virtual soft barrier 260 being less than a threshold distance, and the vehicle 100 being located beyond the virtual soft barrier 260 (e.g., into the third lane 250). In some scenarios, the control system 110 warns the driver when a first threshold distance from the vehicle 100 to the virtual soft barrier 260 is satisfied and directs the electronic steering system 120 of the vehicle to provide the counter-steering nudge when a second threshold distance shorter than the first threshold distance from the vehicle 100 to the virtual soft barrier 260 is satisfied.

In some implementations, the vehicle lane control system 110 sets or adjusts the threshold distance based on one or more received user inputs. In additional implementations, the vehicle lane control system 110 adjusts the threshold distance based on one or more other factors such as a lateral velocity of the vehicle 100, a speed at which the vehicle is traveling, and/or avoidance criticality such as a lane type associated with the wrong third lane 250 and/or objects detected in the wrong third lane 250. As such, the vehicle lane control system 110 may adjust the threshold distance by decreasing a magnitude of the threshold distance in scenarios when the wrong third lane 250 is a traffic lane for traffic in an opposite direction than the current lane 210, the rate at which the vehicle is drifting toward the virtual soft barrier 270 satisfies a drift rate threshold, and/or the presence of pedestrians or parked vehicles are detected in the third lane 250.

In some examples, such actions alert the driver that an unintentional lane departure may be taking place such that the driver, who is responsible for safely operating the vehicle, may take corrective action to prevent or mitigate the unintentional lane departure. For instance, audible and/or visual alerts may indicate the unintentional lane departure. In some examples, the vehicle lane control system 110 vibrates the steering wheel and/or seat to warn the driver that the unintentional lane departure is taking place. Additionally or alternatively, the vehicle lane control system 110 may direct the electronic steering system 120 to take sufficient actions (e.g., exert sufficient counter-steering torque) to steer the vehicle 100, on behalf of or instead of the driver, to prevent or recover from the unintentional lane departure. In some examples, the vehicle lane control system 110 continues to help prevent unintentional lane changes until the intended lane change is completed or until the turn signal lever 140a is deactivated, at which point the vehicle lane control system 110 deactivates the virtual soft barrier 260 and ceases monitoring distances from the vehicle 100 to the virtual soft barrier 260.

In some examples, the vehicle lane control system 110 and/or the electronic steering system 120 selects the intensity of the nudge or counter-steering torque based on one or more sensed conditions, such as a lateral velocity of the vehicle 100, a presence and/or proximity of an object (e.g., another vehicle) in the third lane 250, and/or an avoidance criticality. For example, the vehicle lane control system 110 and/or the electronic steering system 120 may increase the intensity of the nudge or counter-steering torque as an amount of unintentional drift increases, when the vehicle 100 is drifting toward a double line lane marker instead of a single line lane marker, when the virtual soft barrier 260 is near a guard rail, when another vehicle is detected near the vehicle 100 in the third lane 250, etc. In some examples, the vehicle lane control system 110 discontinues the counter-steering torque or nudge in response to a driver steering input.

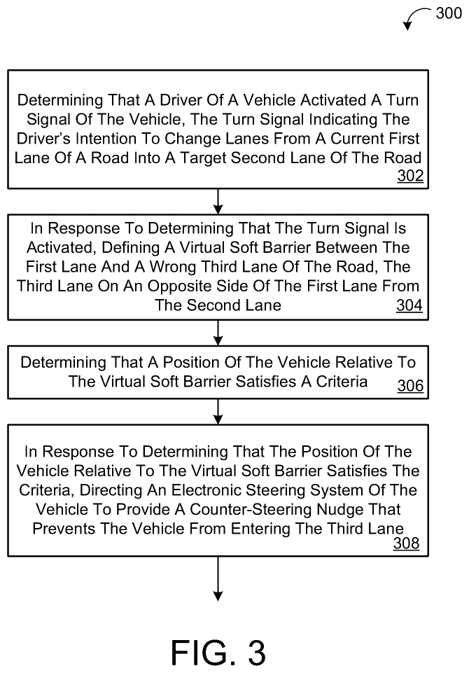

FIG. 3 is a flowchart of an exemplary arrangement of operations for a computer-implemented method 300 of controlling a vehicle lane change. The method 300 includes, at operation 302, determining that a driver of a vehicle (e.g., the vehicle 100) activated a turn signal of the vehicle (e.g., activated the turn signal lever 140a), the turn signal indicating the driver's intention to change lanes from a current first lane of a road (e.g., the first lane 210 of the road 220) into an adjacent target second lane of the road (e.g., the second lane 230 of the road 220).

At operation 304, the method 300 includes, in response to determining that the turn signal is activated, defining a virtual soft barrier (e.g., the virtual soft barrier 260 corresponding to the lane markings 270) between the first lane and a third lane of the road (e.g., the third lane 250 of the road 220), the third lane on an opposite side of the first lane from the second lane.

The method 300 includes, at operation 306, determining that a position of the vehicle relative to the virtual soft barrier satisfies a criteria. Example criteria include a distance from the vehicle 100 to the virtual soft barrier 260 being less than a threshold distance, and the vehicle 100 being located beyond the virtual soft barrier 260 (e.g., into the third lane 250). At operation 308, the method 300 includes, in response to determining that the distance between the vehicle and the virtual soft barrier satisfies the threshold distance, directing an electronic steering system (e.g., the electronic steering system 120) of the vehicle to provide a counter-steering nudge that prevents the vehicle from entering the third lane.

FIG. 4 is schematic view of an example computing device 400 that may be used to implement the systems and methods described in this document. The computing device 400 is intended to represent various forms computing devices such as an electronic control unit (ECU) or an embedded controller for a vehicle. The components shown here, their connections and relationships, and their functions, are meant to be exemplary only, and are not meant to limit implementations of the inventions described and/or claimed in this document. The computing device 400 is disposed at the vehicle 100.

The computing device 400 includes a processor 410 (i.e., data processing hardware), memory 420 (i.e., memory hardware), an optional storage device 430 (i.e., memory hardware), a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
determining that a driver of a vehicle activated a turn signal of the vehicle, the turn signal indicating a driver intention to change lanes from a first lane of a road into a second lane of the road;
in response to determining that the turn signal is activated, defining a virtual soft barrier between the first lane and a third lane of the road, the third lane on an opposite side of the first lane from the second lane;
determining that a position of the vehicle relative to the virtual soft barrier satisfies a criteria; and
in response to determining that the position of the vehicle relative to the virtual soft barrier satisfies the criteria, directing an electronic steering system of the vehicle to provide a counter-steering nudge that prevents the vehicle from entering the third lane.

2. The computer-implemented method of claim 1, wherein determining that the position of the vehicle relative to the virtual soft barrier satisfies the criteria comprises determining that a distance between the vehicle and the virtual soft barrier satisfies a threshold distance.

3. The computer-implemented method of claim 2, wherein the operations further comprise:
receiving a user input; and
setting the threshold distance based on the user input.

4. The computer-implemented method of claim 2, wherein the operations further comprise:
receiving an output of a sensor; and
determining the distance based on the output of the sensor.

5. The computer-implemented method of claim 4, wherein the sensor comprises an optical sensor.

6. The computer-implemented method of claim 5, wherein the optical sensor comprises at least one of a camera, a radio detection and ranging (RADAR) system, or a light detection and ranging (LIDAR) system.

7. The computer-implemented method of claim 1, wherein the operations further comprise:
determining that the turn signal is deactivated; and
in response to determining that the turn signal is deactivated, deactivating the virtual soft barrier.

8. The computer-implemented method of claim 1, wherein the virtual soft barrier comprises a lane marking between the first lane and the third lane.

9. The computer-implemented method of claim 1, wherein the third lane is a shoulder lane.

10. The computer-implemented method of claim 1, wherein the second lane or the third lane is a lane for traffic in an opposite direction.

11. The computer-implemented method of claim 1, wherein the operations further comprise:
receiving a driver steering input; and
discontinuing the counter-steering nudge in response to the driver steering input.

12. The computer-implemented method of claim 1, wherein the operations further comprise adapting a strength of the counter-steering nudge based on a sensed condition.

13. The computer-implemented method of claim 12, wherein the sensed condition comprises at least one of a lateral speed of the vehicle, a presence of an object in the third lane, or an avoidance criticality.

14. A system comprising:
data processing hardware; and
memory hardware in communication with the data processing hardware, the memory hardware storing instructions that when executed on the data processing hardware cause the data processing hardware to perform operations comprising:
determining that a driver of a vehicle activated a turn signal of the vehicle, the turn signal indicating a driver intention to change lanes from a first lane of a road into a second lane of the road;
in response to determining that the turn signal is activated, defining a virtual soft barrier between the first lane and a third lane of the road, the third lane on an opposite side of the first lane from the second lane;
determining that a position of the vehicle relative to the virtual soft barrier satisfies a criteria; and
in response to determining that the position of the vehicle relative to the virtual soft barrier satisfies the criteria, directing an electronic steering system of the vehicle to provide a counter-steering nudge that prevents the vehicle from entering the third lane.

15. The system of claim 14, wherein determining that the position of the vehicle relative to the virtual soft barrier satisfies the criteria comprises determining that a distance between the vehicle and the virtual soft barrier satisfies a threshold distance.

16. The system of claim 15, wherein the operations further comprise:
receiving a user input; and
setting the threshold distance based on the user input.

17. The system of claim 15, wherein the operations further comprise:
receiving an output of a sensor; and
determining the distance based on the output of the sensor.

18. The system of claim 17, wherein the sensor comprises an optical sensor.

19. The system of claim 18, wherein the optical sensor comprises at least one of a camera, a radio detection and ranging (RADAR) system, or a light detection and ranging (LIDAR) system.

20. The system of claim 14, wherein the operations further comprise:
determining that the turn signal is deactivated; and
in response to determining that the turn signal is deactivated, deactivating the virtual soft barrier.

21. The system of claim 14, wherein the virtual soft barrier comprises a lane marking between the first lane and the third lane.

22. The system of claim 14, wherein the third lane is a shoulder lane.

23. The system of claim 14, wherein the second lane or the third lane is a lane for traffic in an opposite direction.

24. The system of claim 14, wherein the operations further comprise:
receiving a driver steering input; and
discontinuing the counter-steering nudge in response to the driver steering input.

25. The system of claim 14, wherein the operations further comprise adapting a strength of the counter-steering nudge based on a sensed condition.

26. The system of claim 25, wherein the sensed condition comprises at least one of a lateral speed of the vehicle, a presence of an object in the third lane, or an avoidance criticality.
